(19) United States
(12) Patent Application Publication
(10) Pub. No.: US 2009/0157427 A1
(43) Pub. Date: Jun. 18, 2009

(54) Method of personalized, independent medical evaluation

(76) Inventor: Winston T. Capel, Bountiful, UT (US)

Correspondence Address: THORPE NORTH & WESTERN, LLP., P.O. Box 1219, SANDY, UT, 84091-1219, US

(21) Appl. No.: 12/075,802

(22) Filed: Mar. 12, 2008

Related U.S. Application Data
(60) Provisional application No. 61/007,616, filed on Dec. 12, 2007.

(51) Int. Cl. G06Q 50/00

(52) U.S. Cl. 705/3

(57) ABSTRACT

A method for enabling a patient and/or a patient's family to make better informed medical decisions with respect to ongoing care from the patient's primary care physician(s) comprising providing a physician consultant under contract directly with the patient to monitor medical treatment and recommendations of a primary care physician(s), wherein the physician consultant is economically independent of any third party which is economically benefited by the patient's treatment. The method further comprises providing independent interpretation and recommendations to the patient and/or the patient's family pursuant to the contract without providing health care treatment to the patient.

### PRIORITY CLAIM

This application claims priority of U.S. Provisional Patent Application Ser. No. 61/007,616 filed on Dec. 13, 2007 entitled “Method of Personalized, Independent Medical Evaluation,” said application being incorporated herein by reference in its entirety.

### BACKGROUND

Fundamental to the receipt of health care is the need for patients and their families to make decisions. Many of these decisions involve unfamiliar complexity for patients and family members. Much of the decision-making required by health care consumers or concerned others is too complex for most and insecurity is a natural consequence. Medical studies report that patients receive only slightly more than 50% of the recommended health care in the United States and that major deficiencies in that health care exist. In addition to this phenomenon of under treatment, patients must also face the risks and reality of over treatment, which is an inherent element of the health care system of the United States. There are risks and dangers with both over and under treatment of medical conditions.

Physicians are the primary source of information about disease and treatments and are best positioned to be this source due to their knowledge of the patient, disease, and treatments. However, a natural knowledge imbalance exists between physicians and patients. Time is a major constraint that prevents physicians from spending the required time to communicate essential elements of understanding for the disease and treatments and how these elements appertain to the patient's unique position in the disease spectrum. Due to such time constraints, a shortage of physicians, and other economic influences, more non-physician providers are in place now than in previous eras. Financial incentives for physicians to control costs creates conflicts of interest that may compromise the interest of patients. For example, discussions of specific treatment options may be forbidden by a health management organization if the treatment option is not covered by insurance. Additionally, a considerable amount of health care is performed in institutions with varying degrees of safety and competency, further impacting the patient's ability to assess the quality of health care they are receiving.

Patients and their families are required to make medical decisions in the context of an emergency. Many of these decisions are of life or death in gravity with the sources of essential knowledge and information being limited to emergency providers only. Clinical outcomes are often dependent on these early decisions that may not be reversible.

Increased complexities in the diagnosis and treatment of disease are the natural consequence of inevitable and ongoing scientific progression. This includes genomic medicine (personalized medicine). The transfer of this derived and evolving clinical/scientific information necessary for the ideal decision making is dependent on patient-physician communications. For reasons outlined above, the communications are often incomplete and decisions are often made with insufficient information.

All patients are required to navigate disease in the context of their health care system. The principals involved within the system(s) include: patient, patient's family, primary treating physician(s), institutions of care (hospitals), insurance companies-in the international context: federal health care systems.

Each principal has complexity and potential conflicts with the patient's best interest. Examples of these complexities and conflicts follow. The patient and family may desire to prolong survival and may encourage or be willing to submit to the exposure to ineffective even toxic therapeutics in the absence of navigable information. Physician behavior is complex-examples of over and under treatment exist. For example the rate of spinal fusion varies dramatically by geography in the United States. The primary treating physician (PTP) may recommend diagnostic and therapeutic measures that may not be based upon the highest quality of scientific data available to the patient. Hospitals with varying degrees of institutional competencies at the delegation of the primary treating physician perform much of the health care-patients have little ability to know or understand the quality of this care (lack of transparency). Insurance companies and federalized health care systems have a financial obligation to control costs. Most decisions by these entities are leveraged by cost considerations. They are required to take a utilitarian approach. This may be in conflict with what is best for the individual patient. Escalating health care costs are mandating reforms that constrict choice; scientific advancement is inevitable and an ongoing process that will offer patients increased clinical benefits including survivability. There is often a significant time lag between identified advancement, clinical application, insurance company or health care system approval for coverage. Insurance companies and healthcare systems may never offer or approve care that is ideal for a patient.

### SUMMARY OF THE INVENTION

It has been observed that it would be advantageous to develop a method for enabling a patient and/or patient's family to make better informed medical decisions. Patients and families need assistance in the navigation of disease and health care systems. In one embodiment of the present invention, a method for enabling a patient and/or a patient's family to make better informed medical decisions with respect to the ongoing diagnosis and treatment of a particular disease by the PTP is disclosed. The method comprises providing an independent physician consultant under contract directly with the patient to monitor medical treatment and recommendations of a PTP, wherein the physician consultant is economically independent of the PTP, a hospital, a health management organization, or any other party economically benefited by the patient's treatment. The method further comprises developing a medical history of the patient as an independent and private resource of the physician consultant, developing a physical profile of the patient based on the patient's unique physical attributes, and updating and integrating the patient's medical history and physical profile with respect to a sequence of current medical activities related to the patient, including activities of the patient's PTP. The method further comprises monitoring and evaluating current medical advice provided by third parties to the patient based on (i) the integrated medical history and physical profile, and (ii) specialized knowledge of the physician consultant in related medical fields and specific recommendations of the PTP. The method further comprises providing independent interpretation and recommendations to the patient and/or the patient's family pursuant to the contract without providing health care treatment to the patient.

In an additional embodiment, the method further comprises providing recommendations to the patient and/or the patient's family regarding specific treatment procedures, specific treating physicians, and/or specific health care facilities. In one aspect of the invention, the physician consultant will not receive financial remuneration from a third party if a patient and/or patient's family follows the physician consultant's recommendations.

In an additional embodiment, the method further comprises educating the patient and/or the patient's family regarding the patient's medical condition with respect to the patient's integrated medical history and physical profile. In an additional embodiment, the physician consultant is professionally independent of the PTP and health care facility.

In one embodiment of the present invention, a method of providing independent coordinated healthcare consultation for a patient, the patient having a primary treating physician responsible for primary diagnosis and treatment of the patient's symptoms is disclosed. The method comprises contracting with a secondary healthcare organization for personalized consultation with an independent physician consultant, wherein said independent physician consultant conducts a physical examination of the patient, reviews the patient's medical history and present treatment procedure and communicates directly with the patient and the patient's primary treating physician to recommend a specific treatment procedure and treatment facility. The secondary healthcare organization and independent physician consultant are economically independent of the independent physician consultant's recommendation. The method further comprises educating the patient and the primary treating physician regarding said recommendation.

In one aspect of the invention, the independent physician consultant is selected from a group of expert physicians with a developed expertise in the diagnosis and treatment of specific medical conditions. In an additional aspect, the group of experts are professionally independent of the PTP and recommended treatment facility.

In another embodiment, a method of providing advisory health care information to patients with respect to the patient's ongoing care from a primary treating physician is disclosed comprising providing a network of healthcare specialists available for private patient consultation, contracting with a patient and/or a patient's legal representative for private health care consultation services, and assigning a network healthcare specialist to the patient as a physician consultant. The method further comprises providing a history of healthcare treatment of the patient to the physician consultant, conducting a physical examination of the patient, and providing a physical profile of the patient to the physician consultant. The method further comprises providing recurring independent recommendations and evaluations from the physician consultant to the patient and the primary treating physician in connection with ongoing services from the primary treating physician and a health care facility without providing treatment services to the patient, wherein the physician consultant is professionally independent from the PTP and the health care facility.

In one embodiment of the invention, the physician consultant is professionally independent from a health insurance provider. In another embodiment, the method further comprises educating the patient and/or the patient's legal representative regarding the patient's medical condition with respect to the patient's physical profile and history of healthcare treatment.

In one embodiment, the method further comprises conducting diagnostic testing to identify a specific disease. In another embodiment, the method further comprises conducting diagnostic testing to identify a disease sub-type. In yet another embodiment, the method comprises conducting genetic studies to determine the genomic personality of the disease. In another embodiment, the method comprises recommending treatment procedures specific to disease sub-types.

### DESCRIPTION OF FIGURES

Additional features and advantages of the invention will be apparent from the detailed description which follows, taken in conjunction with the accompanying drawings, which together illustrate, by way of example, features of the invention; and, wherein:

FIG. 1 is a flowchart illustrating multiple embodiments of the present invention;

FIG. 2 is a flowchart illustrating multiple embodiments of the present invention; and

FIG. 3 is a flowchart illustrating multiple embodiments of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Health care systems sporadically report performance measures through the press to the lay public. These include: medical errors, infection, and death rates. Patients are also informed about the geographical variation in health care utilization and frequency of surgical procedures for a number of conditions. This is important information to the health care consumer, but without qualification and explanation it creates insecurity in patients.

An estimated 74% of American internet users have used the internet for health information. A significant number of patients have difficulty interpreting and understanding the information found. Additionally, information must be applied (i.e., contextualized) to the patient's unique position in the disease spectrum and many patients find this to be difficult.

A considerable amount of health care is performed in institutions with varying degrees of safety and competency. Many institutional relationships are compulsory (as dictated by an insurance provider) or strongly biased by other professional and/or financial incentives. For example, the physician ownership of specialty hospitals and ambulatory surgery centers raises issues of over treatment to maximize profit and/or under treatment of medical problems that are not covered by insurance.

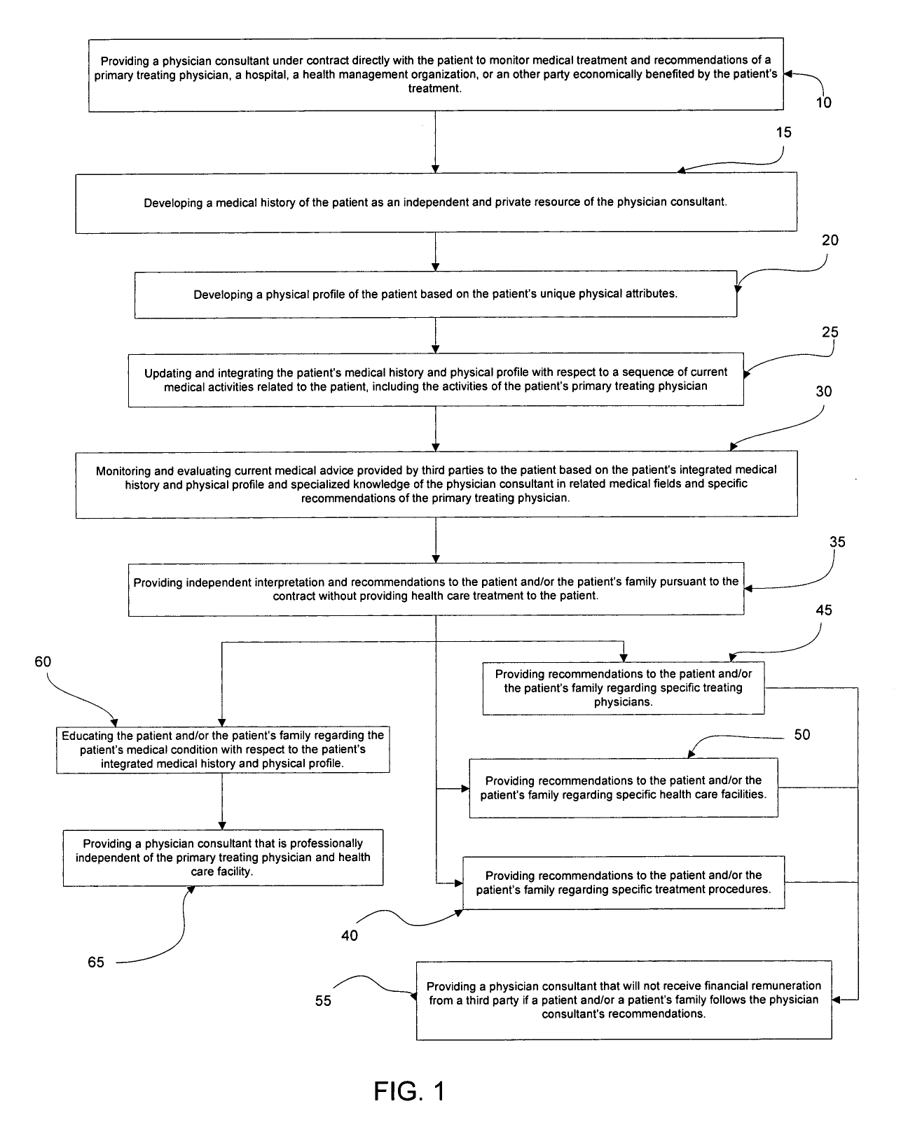

It has been observed that it would be advantageous to develop a method for enabling a patient and/or patient's family to make better informed medical decisions and to receive personalized consultation regarding a patient's treatment and personalized management of the patient's treatment. Referring now to FIG. 1, in one embodiment of the present invention, a method for enabling a patient and/or a patient's family to make better informed medical decisions with respect to ongoing primary medical care from the patient's PTP is disclosed. The method comprises providing a physician consultant under contract directly with the patient to monitor medical treatment and recommendations of a PTP, wherein the physician consultant is economically independent of the PTP, a hospital, a health management organization, or any other party economically benefited by the patient's treatment (10). The method further comprises developing a medical history of the patient as an independent and private resource of the physician consultant (15), developing a physical profile of the patient based on the patient's unique physical attributes (20), and updating and integrating the patient's medical history and physical profile with respect to a sequence of current medical activities related to the patient, including activities of the patient's PTP (25). The method further comprises monitoring and evaluating current medical advice provided by third parties to the patient based on (i) the integrated medical history and physical profile, and (ii) specialized knowledge of the physician consultant in related medical fields and specific recommendations of the primary treating physician(s) (30). The method further comprises providing independent interpretation and recommendations to the patient's and/or the patient's family pursuant to the contract without providing health care treatment to the patient (35). Advantageously, the physician consultant is free from many of the financial and professional encumbrances that bias primary treating physicians in today's healthcare industry thereby allowing the physician consultant to act as the patient or the patient's family's loyal advisor.

It is important to note that the independent physician consultant does not replace the patient's PTP. Rather, the independent physician consultant is a resource to all health care team members with ongoing bidirectional communication to optimize decision-making. In one aspect of the invention, as the chief advisor and repository of the best scientific information related to the disease and treatment of the disease, the independent physician consultant will conduct team meetings providing clear access with the patient, the patient's family, and the PTP. The decision-making is based upon the best scientific information known and applied to the unique status of the patient. All decisions are qualified and quantified based upon current clinical data and best evidence for effectiveness (evidence-based medicine). The independent physician consultant is in possession of the best practices articulated upon the premises of evidence-based medicine (EBM). In one aspect of the invention, the independent physician consultant and the PTP will process all data independently (at least initially) allowing for two professionals to fully review available information. Under the direction of the independent physician consultant, the interpretations and opinions of both physicians will be amalgamated into the ideal or best option for the patient.

All patients possess a state of uniqueness requiring the independent physician consultant to understand these unique elements. The independent physician consultant will integrate the unique patient/disease elements with the highest level of science known to assist the entire health care team in the navigation of the disease. Navigation includes, but is not limited to, the best diagnostics and therapeutics for each unique patient. The independent physician consultant is an expert disease navigator that is loyal to the patient and engaged to lower the insecurity of disease and maximize clinical outcomes.

In an additional embodiment, the method further comprises providing recommendations to the patient and/or the patient's family regarding specific treatment procedures (40), specific treating physicians (45), and/or specific health care facilities (50). In one aspect of the invention, the physician consultant will not receive financial remuneration from a third party if a patient and/or patient's family follows the physician consultant's recommendations (55). In an additional embodiment, the method further comprises educating the patient and/or the patient's family regarding the patient's medical condition with respect to the patient's integrated medical history and physical profile (60). In this aspect, the physician consultant acts as an expert educator providing knowledge and understanding of the patient's disease to the highest level achievable and/or desired by the patient. In an additional embodiment, the physician consultant is professionally independent of the PTP and health care facility (65).

Advantageously, in one embodiment of the invention, the physician consultant remains loyal only to the patient and/or the patient's family, being free from biasing economic, professional, or social influences. It is understood that treatment, as referenced herein, refers to all aspects of the patient's healthcare, including, but not limited to, diagnosis and evaluation of a patient's physical and mental state, treatment of the patient's physical and mental state (e.g., surgery, therapy, pain management, etc.), and rehabilitation of the patient. In some instances, the diagnosis, treatment, and rehabilitation cycles are overlapped and intermingled with one another and are ongoing for the duration of the patient's life. In one aspect of the invention, the physician consultant initially appointed to provide consultation continues to provide consultation to the patient, so long as the patient may benefit from his expertise. In an additional aspect, the number of patients that a physician consultant may service will be limited. In one embodiment, this limitation is imposed to ensure that the physician consultant has the time necessary to service the patients' needs.

Many times, health care facilities and PTP's available to a patient are restricted to within a pre-approved group of facilities and individuals. Members of those groups are less inclined to make recommendations outside of that group. In an additional embodiment, the independent physician consultant assists patients and families in the navigation of places and providers of health care (e.g., PTP's, hospitals, etc.) through all stages of the disease as described herein. This navigation also includes assisting patients and a patient's family in navigating outside of a patient's pre-approved group on both a domestic and international level when the pre-approved group does not offer the highest level of evidence-based or most idealized diagnostics and therapeutics for the disease.

As discussed herein, it is understood that reference to financial independence is limited to those persons or entities that stand to gain a direct financial benefit from the course of treatment of the patient. This includes, for example, officers, directors, and/or employees that influence the day-to-day operations of a specific entity. For example, a pharmaceutical company may gain a direct financial benefit from a particular course of chemotherapy which a patient may undergo as the patient and/or the patient's insurance company would pay for the chemotherapy. Treating physicians often have long-lasting professional relationships with pharmaceutical companies, receive compensation for promoting certain pharmaceutical products, and/or receive excessive amounts of free samples of pharmaceutical products in return for an endorsement of a particular pharmaceutical product. In like manner, a treating physician, hospital, rehabilitation center, etc. all stand to gain a direct financial benefit from a particular course of treatment of a patient. Similarly, a patient's insurance company is incentivized to pay only for those treatments which it deems to be reasonable under the circumstances in an effort to maximize company profits. For example, a treating physician that considers two procedures to be equivalent would likely recommend a procedure that he may be most qualified to conduct. While the treating physician may do so with only the best of intentions, he unwarily creates unwanted bias in his own recommendation. Each of these parties therefore stands to gain a direct financial benefit from a particular course of treatment.

Examples of individuals or entities which would not gain a direct financial benefit from a patient's treatment as referenced herein includes shareholders of a pharmaceutical company or an insurance company, third party contractors that work for healthcare providers, spouses of treating physicians, etc. These types of individuals would typically not be considered to have any direct influence over the day-to-day activities of these entities. As noted herein, one objective of the present invention is to provide bias-free medical consultation to patients and/or a patient's family. Due to the unmistakable financial bias interjected into the practice of medicine today, the present system of medical care fails in that regard.

Professional bias also has a negatively biasing influence in our present system of medical care. In many instances, treating physicians have professional relationships with certain hospitals, healthcare facilities, and/or other treating physicians. The physicians perform surgeries or other medical procedures, refer other physicians, and/or receive referrals from a particular healthcare facility and/or other treating physician. As a result, a treating physician may have a negative professional bias when recommending a particular healthcare facility or other treating physician to a patient. For example, a treating physician that considers two healthcare facilities to be roughly equivalent would likely recommend a healthcare facility with which he maintains a professional relationship, without fully investigating other healthcare facilities. Again, while the treating physician may do so with only the best of intentions, he unwarily creates unwanted bias in his recommendation. Similarly, physicians have professional relationships and agreements with insurance companies. While said professional relationship is not intended to harm, it is impossible to ignore the negative bias that may impact a treating physician's recommendation. One objective of the present invention is to relieve the physician consultant of the unwanted professional biases that exist in today's practice of medicine to secure medical consultation that is truly independent.

In one embodiment of the invention, a patient's primary care physician (PCP) is also included as a member of the patient's health care team and is contacted by the independent physician consultant. While PCPs are often asked to answer the myriad of complex questions posed by patients recently diagnosed with serious diseases, they are generally unequipped and untrained in those particular areas of medicine. However, a PCP may offer insight into a patient's family history, or other important piece of information unique to the patient.

In one aspect of the invention, the physician consultant is equipped with a personal digital assistant (PDA). The patient is given contact information of the physician consultant and may contact the physician consultant at any time. When contacted, the physician consultant may instantly reference a database on his PDA having the integrated patient's medical history and physical profile and current medical activities related to the patient. In one embodiment, the PDA is synchronized with e-mail from the patient's treating physician, treatment facility, and/or other expert physician consultant. In another embodiment, the PDA is synchronized with a central database which is maintained and updated with current information collected from the patient's treatment physician and/or treatment facility. Additionally, the PDA is synchronized with a central database which is maintained and updated with current information regarding the most recent clinical literature of the procedures and practices relevant to the patient's unique needs. In one embodiment, the PDA is configured to integrate the most recent clinical literature, the patient's present status and vital statistics, the patient's medical history and physical profile, and any notices from the patient's treating physician and/or treatment facility into a predetermined format. In one aspect, the PDA has a graphical user interface that provides the physician consultant with alternative “windows” providing information related to the most recent clinical literature, the patient's present status and vital statistics, the patient's medical history and physical profile, and any notices from the patient's treating physician and/or treatment facility into a predetermined format. In yet another embodiment, the PDA is programmed to alert the physician consultant when a predetermined event regarding the patient occurs (e.g., a patient's vital statistics change, a patient is scheduled to receive treatment, a patient has completed a therapy session, etc.).

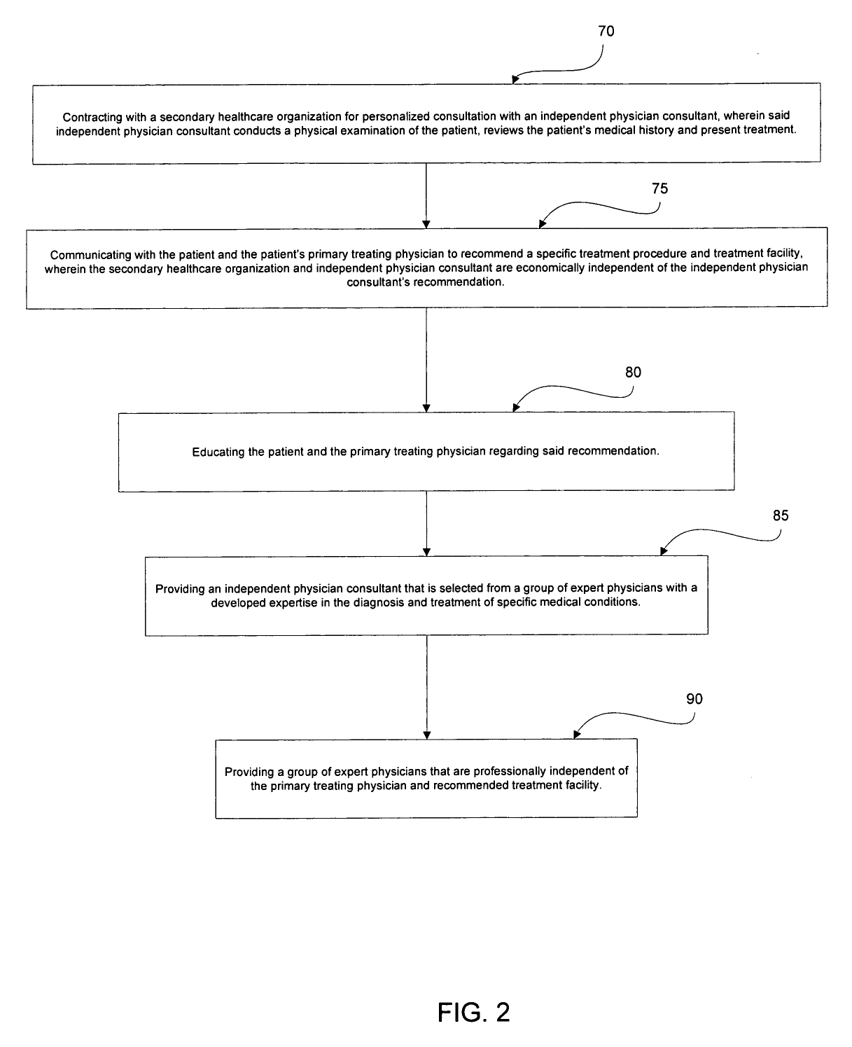

Referring now to FIG. 2, in one embodiment of the present invention, a method of providing independent coordinated healthcare consultation for a patient is disclosed, wherein the patient has a PTP responsible for primary diagnosis and treatment of the patient's symptoms. The method comprises contracting with a secondary healthcare organization for personalized consultation with an independent physician consultant, wherein said independent physician consultant conducts a physical examination of the patient, reviews the patient's medical history and present treatment procedure (70) and communicates directly with the patient and the patient's primary treating physician to recommend a specific treatment procedure and treatment facility. The secondary healthcare organization and independent physician consultant are economically independent of the independent physician consultant's recommendation (75). The method further comprises educating the patient and the primary treating physician regarding said recommendation (80). In an additional embodiment, the method further comprises presenting options to a patient with respect to disease treatment alternatives, risks associated with each alternative, and the likelihood of success of each alternative.

In one aspect of the invention, the independent physician consultant is selected from a group of expert physicians with a developed expertise in the diagnosis and treatment of specific medical conditions (85). In an additional aspect, the group of experts is professionally independent of the primary treating physician and recommended treatment facility (90).

Advantageously, one embodiment of the present invention allows for unbiased recommendations of specific treating physicians, treatment facilities, and treatment procedures. In this aspect, no direct financial or professional bias is present to influence recommendations as the group of experts remains financially and professionally independent from all aspects of physical treatment of the patient. In the event any member of the group or the physician consultant himself has a professional relationship with a treating physician and/or a healthcare facility, the affected party (i.e., the member with the professional relationship) would recuse himself from offering consultation. In one embodiment, any previous professional and/or personal relationships would also be sufficient for the effected party to recuse himself from offering consultation. As a result, negatively biasing professional and social pressures would be eliminated from the personalized consultation process. The end result of this aspect is that the extremely difficult decisions that must be made by patients and/or their families can be made in a transparent environment. The patients and/or the patient's family are enabled with a transparent, unbiased evaluation of the facilities and persons that deliver health care treatment.

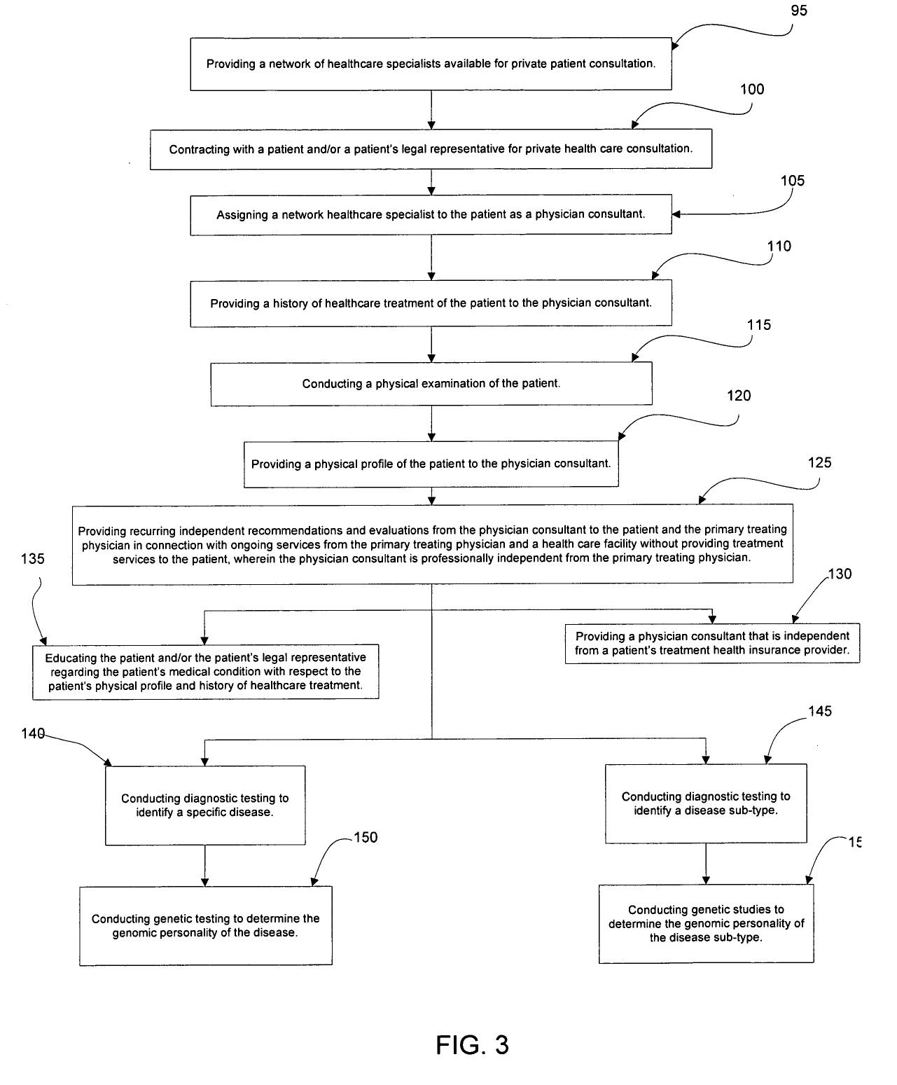

Referring now to FIG. 3, in another embodiment, a method of providing advisory health care information to a patient with respect to the patient's ongoing care from a primary treating physician is disclosed comprising providing a network of healthcare specialists available for private patient consultation (95), contracting with a patient and/or a patient's legal representative for private health care consultation services (100), and assigning a network healthcare specialist to the patient as a physician consultant (105). The method further comprises providing a history of healthcare treatment of the patient to the physician consultant (110), conducting a physical examination of the patient (115), and providing a physical profile of the patient to the physician consultant (120). The method further comprises providing recurring independent recommendations and evaluations from the physician consultant to the patient and the primary treating physician in connection with ongoing services from the primary treating physician and a health care facility without providing treatment services to the patient, wherein the physician consultant is professionally independent from the primary treating physician and the health care facility (125). In one aspect of the invention, the physician consultant is not reimbursed as services are rendered or pre-paid on a per service basis. Rather, the patient and/or the patient's family pays a monthly premium or a yearly premium for unlimited access to the physician consultant.

In one embodiment of the invention, the physician consultant is professionally independent from a health insurance provider (130). In another embodiment, the method further comprises educating the patient and or the patient's legal representative regarding the patient's medical condition with respect to the patient's physical profile and history of healthcare treatment (135).

In one embodiment, the method further comprises conducting diagnostic testing to identify a specific disease (140). In another embodiment, the method further comprises conducting diagnostic testing to identify a disease sub-type (145). In yet another embodiment, the method comprises conducting genetic studies to determine the genomic personality of the disease (150). In another embodiment, the method comprises recommending treatment procedures specific to disease sub-types (155).

Advantageously, the method permits personalized healthcare consultation to a patient and/or a patient's family that is unique and tailored to the patient's needs. The physician consultant is not accountable to any peer group, insurance agency, healthcare facility, or other third party that may have a direct financial interest in treatment of the patient. In one aspect of the invention, the physician consultant himself is barred from providing healthcare treatment to the patient in an effort to further free the physician consultant from financial encumbrances that may bias the outcome of his or her consultation. In an additional aspect, the physician consultant acts as a critical member of the patient's healthcare team. While he does not provide healthcare treatment to the patient, the physician consultant works closely with the patient's treating physician and the patient's chosen healthcare facility to recommend proper treatment procedures. As part of this, the physician consultant educates the treating physician regarding state of the art procedures, medicines, orthopedic devices, chemical therapies, rehabilitation methods, and/or other healthcare devices that are specifically suited to the patient's unique needs. Additionally, the physician consultant may provide similar education to the patient's healthcare facility. In this manner, the physician consultant guides the healthcare team in making the best decisions regarding treatment options based upon the best interpretation of current clinical literature and practice.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for enabling a patient and/or a patient's family to make better informed medical decisions with respect to ongoing primary medical care from the patient's primary treating physician(s), the method comprising:
a) providing a physician consultant under contract with the patient to monitor medical treatment and recommendations of a primary treating physician(s), wherein the physician consultant is economically independent of the primary treating physician, a hospital, a health management organization, or any other party receiving a direct economic benefit derived from the patient's treatment;
b) developing a medical history of the patient as an independent and private resource of the physician consultant;
c) developing a physical profile of the patient based on the patient's unique physical attributes;
d) updating and integrating the patient's medical history and physical profile with respect to a sequence of current medical activities related to the patient, including activities of the patient's primary treating physician(s);
e) monitoring and evaluating current medical advice provided by third parties to the patient based on (i) the integrated medical history and physical profile of step
d) and (ii) specialized knowledge of the physician consultant in related medical fields and specific recommendations of the primary treating physician(s); and
f) providing independent interpretation and recommendations to the patient and/or the patient's family pursuant to the contract without providing health care treatment to the patient.

2. The method of claim 1, further comprising providing recommendations to the patient and/or the patient's family regarding specific treatment procedures.

3. The method of claim 1, further comprising providing recommendations to the patient and/or the patient's family regarding specific treating physicians.

4. The method of claim 1, further comprising providing recommendations to the patient and/or the patient's family regarding specific health care facilities.

5. The method of claim 2 wherein the physician consultant will not receive financial remuneration from a third party if a patient and/or patient's family follows the physician consultant's recommendations.

6. The method of claim 3 wherein the physician consultant will not receive financial remuneration from a third party if a patient and/or patient's family follows the physician consultant's recommendations.

7. The method of claim 4 wherein the physician consultant will not receive financial remuneration from a third party if a patient and/or patient's family follows the physician consultant's recommendations.

8. The method of claim 1, wherein the physician consultant is professionally independent of the primary treating physician and health care facility.

9. A method of providing independent coordinated healthcare consultation for a patient, the patient having a primary treating physician responsible for primary diagnosis and treatment of the patient's symptoms, the method comprising:
(a) contracting with a secondary healthcare organization for personalized consultation with an independent physician consultant, wherein said independent physician consultant conducts a physical examination of the patient, reviews the patient's medical history and present treatment procedure;
(b) communicating with the patient and the patient's primary treating physician to recommend a specific treatment procedure and treatment facility, wherein the secondary healthcare organization and independent physician consultant are economically independent of the independent physician consultant's recommendation and; and
(c) educating the patient and the primary treating physician regarding said recommendation.

10. The method of claim 9, wherein the independent physician consultant is selected from a group of expert physicians with a developed expertise in the diagnosis and treatment of specific medical conditions.

11. The method of claim 9, wherein the group of experts is professionally independent of the primary treating physician and recommended treatment facility

12. A method of providing advisory health care information to patients with respect to the patient's ongoing care from a primary treating physician, comprising:
(a) providing a network of healthcare specialists available for private patient consultation;
(b) contracting with a patient and/or a patient's legal representative for private health care consultation services;
(c) assigning a network healthcare specialist to the patient as a physician consultant;
(d) providing a history of healthcare treatment of the patient to the physician consultant;
(e) conducting a physical examination of the patient;
(f) providing a physical profile of the patient to the physician consultant;
(e) providing recurring independent recommendations and evaluations from the physician consultant to the patient and the primary treating physician in connection with ongoing services from the primary treating physician and a health care facility without providing treatment services to the patient, wherein the physician consultant is professionally independent from the primary treating physician and the health care facility.

13. The method of claim 12, wherein the physician consultant is professionally independent from a patient's primary health insurance provider.

14. The method of claim 12, further comprising educating the patient and or the patient's legal representative regarding the patient's medical condition with respect to the patient's physical profile and history of healthcare treatment.

15. The method of claim 12, further comprising conducting diagnostic testing to identify a specific disease.

16. The method of claim 12, further comprising conducting diagnostic testing to identify a disease sub-type.

17. The method of claim 15, further comprising conducting genetic studies to determine the genomic personality of the disease.

18. The method of claim 16, further comprising recommending treatment procedures specific to disease sub-types.
